(19) United States
(12) Patent Application Publication
(10) Pub. No.: US 2025/0147693 A1
(43) Pub. Date: May 8, 2025

(54) STORAGE DEVICE AND STORAGE SYSTEM

(71) Applicant: SAMSUNG ELECTRONICS CO., LTD., Suwon-si (KR)

(72) Inventors: Jooyoung HONG, Suwon-si (KR); Jea-Young KWON, Suwon-si (KR); Jaesub KIM, Suwon-si (KR); Yangwoo ROH, Suwon-si (KR); Hyun-Ho SEO, Suwon-si (KR); Junyong UHM, Suwon-si (KR)

(73) Assignee: SAMSUNG ELECTRONICS CO., LTD., Suwon-si (KR)

(21) Appl. No.: 18/813,697

(22) Filed: Aug. 23, 2024

(30) Foreign Application Priority Data
Nov. 2, 2023 (KR) 10-2023-0150213

(51) Int. Cl. G06F 3/06

(52) U.S. Cl. CPC G06F 3/0659; G06F 3/0611; G06F 3/0679

(57) ABSTRACT

A storage system includes a host, and a storage device configured to receive, from the host, a plurality of first type commands, measure a plurality of latencies of the plurality of first type commands, count a number of occurrences of the plurality of latencies within a first time period, the first time period being a time length among the plurality of latencies, generate latency data including time points when each of the plurality of first type commands are received, based on the number of occurrences exceeding a predetermined threshold value, and output, to the host, the latency data based on an asynchronous event request (AER) command being received from the host.

### CROSS-REFERENCE TO RELATED APPLICATIONS

This application claims benefit of priority under 35 U.S.C. § 119 to Korean Patent Application No. 10-2023-0150213, filed on Nov. 2, 2023, in the Korean Intellectual Property Office, the disclosure of which is incorporated by reference herein in its entirety.

### BACKGROUND

### 1. Field

The present disclosure relates generally to storage devices, and more particularly, to a storage device with an Asynchronous Event Request (AER) command and a storage system including the same.

### 2. Description of Related Art

A storage device may refer to a device that may store data under control of a host device such as, but not limited to, a computer, a smart phone, a smart pad, or the like. The storage device may be and/or may include a device that may store data in a magnetic disk such as, but not limited to, a hard disk drive (HDD), and/or a device that may store data in a semiconductor memory such as, but not limited to, a non-volatile memory (NVM), a solid state drive (SSD), a memory card, or the like.

An unexpected latency may occur during an operation of the storage device. In response, the storage device may collect a state at a time point when the latency occurs. A host may acquire the state of the storage device through periodic polling, for example. However, the host and the storage device may be burdened with the collecting and acquiring of the state of the storage device even if a latency has not occurred in the storage device. Thus, there exists a need for further improvements in storage device technology, as the performance of the host and the storage device may be constrained by periodic polling to detect a latency issue.

### SUMMARY

One or more example embodiments of the present disclosure provide a storage system capable of detecting a latency issue without periodic polling of a host.

According to an aspect of the present disclosure, a storage system includes a host, and a storage device configured to receive, from the host, a plurality of first type commands, measure a plurality of latencies of the plurality of first type commands, count a number of occurrences of the plurality of latencies within a first time period, the first time period being a time length among the plurality of latencies, generate latency data including time points when each of the plurality of first type commands are received, based on the number of occurrences exceeding a predetermined threshold value, and output, to the host, the latency data based on an asynchronous event request (AER) command being received from the host.

According to an aspect of the present disclosure, an operating method of a storage system includes receiving an operating condition of a latency issue detection operation, generating a latency table based on the operating condition, receiving an AER command, receiving a plurality of first type commands, measuring a plurality of latencies of the plurality of first type commands, counting a number of occurrences of the plurality of latencies within a first time period, the first time period being a time length among the plurality of latencies, detecting a latency issue based on the number of occurrences exceeding a predetermined threshold value, and transmitting latency data including time points when each of the plurality of first type commands are received, based on the AER command.

According to an aspect of the present disclosure, a storage device includes a host interface configured to receive a plurality of first type commands, a memory storing instructions and one or more processors communicatively coupled to the host interface and to the memory, wherein the one or more processors are configured to execute the instructions to measure a plurality of latencies of the plurality of first type commands, count a number of occurrences of the plurality of latencies within a first time period, the first time period being a time length among the plurality of latencies, generate latency data including time points when each of the plurality of first type commands are received, based on the number of occurrences exceeding a predetermined threshold value, and output, through the host interface, the latency data based on an AER command.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a view showing a storage system, according to an embodiment;

FIG. 2 is a view showing a storage controller, according to an embodiment;

FIG. 3 is a view showing a non-volatile memory (NVM), according to an embodiment;

FIG. 4 is a flowchart showing an operating method of the storage system, according to an embodiment;

FIG. 5 is a flowchart showing an operation of detecting a latency issue according to FIG. 4, according to an embodiment;

FIG. 6 is a view showing a latency table, according to an embodiment;

FIG. 7 is a view showing a storage system, according to an embodiment;

FIG. 8 is a view showing an operating method of the storage system according to FIG. 7, according to an embodiment; and

FIG. 9 is a block diagram showing an SSD system, according to an embodiment.

### DETAILED DESCRIPTION

The present disclosure is described more fully hereinafter with reference to the accompanying drawings, in which embodiments of the disclosure are shown. As those skilled in the art may understand, the described embodiments may be modified in various different ways, without departing from the spirit or scope of the present disclosure.

Accordingly, the drawings and description are to be regarded as illustrative in nature and not restrictive. Like reference numerals designate like elements throughout the specification. In the flowchart described with reference to the drawings, an order of operations may be changed, various operations may be merged, a certain operation may be divided, and a certain operation may not be performed.

In addition, a singular form may be intended to include a plural form as well, unless the explicit expression such as “one” or “single” is used. Terms including ordinal numbers such as first, second, and the like may be used only to describe various constituent elements, and are not to be interpreted as limiting these constituent elements. These terms may be used for a purpose of distinguishing one constituent element from other constituent elements.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

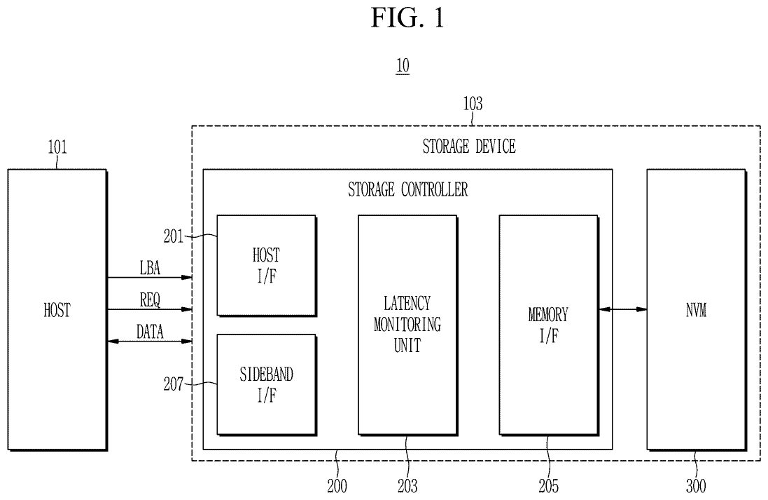

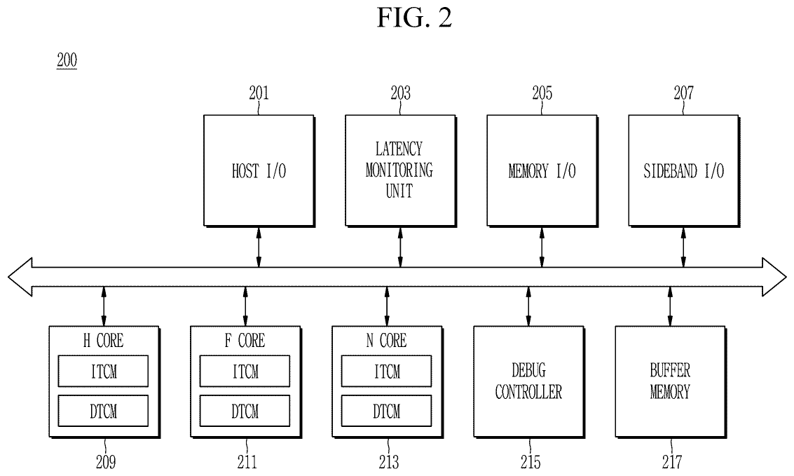

FIG. 1 is a view showing a storage system, according to an embodiment. FIG. 2 is a view showing a storage controller, according to an embodiment.

The storage system 10 may be included in user devices such as, but not limited to, a personal computer (PC), a laptop computer, a server, a media player, a digital camera, or the like, or an automotive device such as, but not limited to, a navigation system, a black box, a vehicle electronic device, or the like. Alternatively or additionally, the storage system 10 may be included in a mobile system such as, but not limited to, a mobile phone, a smart phone, a tablet PC, a wearable device, a healthcare device, an Internet of things (IoT) device, or the like.

As shown in FIG. 1, the storage system 10 may include a host 101 and a storage device 103.

The host 101 may control an overall operation of the storage system 10.

In an embodiment, the host 101 may be and/or may include a central processing unit (CPU), a processor core (e.g., such as an application processor (AP)), or a computing node connected through a network that may be configured to control the storage system 10.

The host 101 may provide a request signal REQ and a logical block address LBA to the storage device 103. For example, the request signal REQ may be and/or may include a command for storing data DATA in the storage device 103. As another example, the request signal REQ may be and/or may include a command for reading data DATA stored in the storage device 103. In an embodiment, the request signal REQ may be and/or may include a command for obtaining information on a state of the storage device 103. In an embodiment, the request signal REQ may be and/or may include a command for setting the storage device 103 to perform a latency issue detection operation. For example, the host 101 may transmit an operating condition that may be needed to perform the latency issue detection operation of the storage device 103 as the data DATA, along with the command for setting the storage device 103 to perform the latency issue detection operation.

The storage device 103 may be accessed by the host 101. The storage device 103 may store the data DATA and/or may process the data DATA in response to the request signal REQ from the host 101.

For example, the storage device 103 may be and/or may include a solid state drive (SSD), a smart SSD, an embedded multimedia card (eMMC), an embedded universal flash storage (eUFS) memory device, a universal flash storage (UFS) memory card, a compact flash (CF) memory card, a secure digital (SD) memory card, a micro secure digital (micro-SD) memory card, a mini secure digital (mini-SD) memory card, an extreme Digital (xD) memory card, a memory stick, or the like.

In an embodiment, the storage device 103 may include a storage controller 200 and a non-volatile memory (NVM) 300.

The NVM 300 may be and/or may include a plurality of storage units. For example, each of the plurality of storage units may include a vertical NAND (V-NAND) flash memory of a two-dimensional (2D) structure and/or a three-dimensional (3D) structure. However, the present disclosure is not limited in this regard. For example, the plurality of storage units may also include another type of non-volatile memory such as, but not limited to, a phase-change random-access memory (PRAM), a resistive random-access memory (ReRAM), or the like. As another example, each of the plurality of storage units may include, but not be limited to, a magnetic RAM (MRAM), a spin-transfer torque MRAM, a conductive bridging RAM (CBRAM), a ferroelectric RAM (FRAM), or various other types of memories.

The storage controller 200 may control an overall operation of the storage device 103. In an embodiment, the storage controller 200 may be and/or may include a CPU, a controller, an application specific integrated circuit (ASIC), or the like.

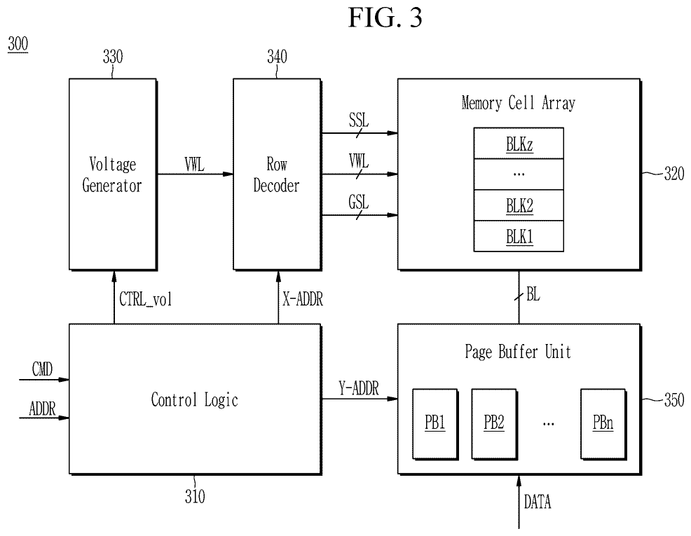

For example, the storage controller 200 may provide a signal (e.g., an address ADDR, a command CMD, a control signal CTRL, or the like as described with reference to FIG. 3) for controlling the NVM 300 in response to the request signal REQ or the like received from the host 101. That is, the storage controller 200 may provide signals to the NVM 300 to write data in the NVM 300 and/or to read data from the NVM 300. In an embodiment, the storage controller 200 and the NVM 300 may exchange data with each other.

Referring to FIG. 2 together, the storage controller 200 may include a host interface (I/F) 201, a latency monitoring unit (or a latency monitoring portion) 203, a memory I/F 205, a sideband I/F 207, an H core 209, an F core 211, an N core 213, a debug controller 215, and a buffer memory 217.

The host I/F 201 may transmit and/or receive a packet to and/or from the host 101. The packet transmitted from the host 101 through the host I/F 201 may be and/or may include a command CMD, data DATA to be written in the NVM 300, or the like. The packet transmitted from the host I/F 201 to the host 101 may be and/or may include a response to the command CMD, data DATA read from the NVM 300, or the like.

For example, the host I/F 201 may communicate based on a peripheral component interconnect express (PCIe) interface protocol. The host I/F 201 may adopt and/or implement one or more of various interface protocols such as, but not limited to, a universal serial bus (USB) protocol, a MultiMediaCard (MMC) protocol, an AT Attachment (ATA) protocol, a serial AT Attachment (SATA) protocol, a parallel AT Attachment (PATA) protocol, a small computer system interface (SCSI) protocol, a serial attached SCSI (SAS) protocol, an enhanced small disk interface (ESDI) protocol, an integrated drive electronics (IDE) protocol, a Non-Volatile Memory Express (NVMe) protocol, or the like.

In an embodiment, when the host 101 uses the NVMe protocol, the storage device 103 may use an asynchronous event request (AER) command that may be specified in an NVMe specification or standard. The storage device 103 may perform a request of the host 101 using the AER command. Alternatively or additionally, when a predetermined interfacing method between the host 101 and the storage device 103 is not the NVMe protocol, the storage device 103 may use a request command and/or signal corresponding to the AER command.

The latency monitoring unit 203 may perform a latency detection operation within the storage device 103. For example, the latency monitoring unit 203 may collect the state at the time point when a latency occurs in the storage device 103, and may generate a debug log based on the collected information. In an embodiment, the debug log may include latency data. In an embodiment, the latency may be and/or may represent a time length from a time point when the storage device 103 receives the request signal REQ from the host 101 (e.g., a time point when the command is received) to a time point when the storage device 103 transmits data DATA to the host 101 in response to the request signal REQ. For example, the latency data may be log data on the latency of the storage device 103. In an embodiment, the latency data may include at least one of the time length of the latency, a time point when the command causing the latency is received, information on the command causing the latency, or the like. However, the present disclosure is not limited thereto, and the latency data may include additional information on a state of the storage device 103 in which the latency may occur, or the like, as well as, the information on the command causing the latency.

In an embodiment, the latency monitoring unit 203 may transmit the latency data to the host 101 in response to the request signal REQ received from the host 101. In such an embodiment, the latency monitoring unit 203 may transmit the latency data to the host 101 through the host I/F 201 and/or the sideband I/F 207.

The latency monitoring unit 203 may divide the time length of the latency into a plurality of time periods (e.g., a plurality of time sections). The latency monitoring unit 203 may count the number of latency occurrences (e.g., occurrences of latencies) included in each time period. In an embodiment, the latency monitoring unit 203 may divide the time length of the latency into the plurality of time periods based on an operating condition received from the host 101. For example, the operating condition may include the number of the plurality of time periods dividing the length of the latency, a range of each of the time periods, a threshold value for the number of the latency occurrences of each of the time periods, or the like, that is included in a latency table generated later by the storage device 103.

In an embodiment, the latency monitoring unit 203 may divide the time length of the latency into the plurality of time periods based on predetermined information. For example, the latency monitoring unit 203 may generate the latency table including the plurality of time periods and the number of the latency occurrences within each time period. The latency monitoring unit 203 may generate a separate latency table for each command type. For example, the latency monitoring unit 203 may generate a latency table corresponding to each of a read command, a write command, and a data set management command. The data set management command may be and/or may include a command for the host 101 to invalidate data of the storage device 103. For example, a data set management command may be and/or may include a trim command. The trim command may refer to a command that may identify a file deleted from the host 101 to erase data corresponding to the deleted file from the storage device 103.

In an embodiment, the latency monitoring unit 203 may determine that a latency issue occurs if or when the number of the latency occurrences within a certain time period exceeds a predetermined threshold value. Subsequently, the latency monitoring unit 203 may determine that the storage device 103 may need confirmation from the host 101, and may transmit the latency data to the host 101. In an embodiment, the latency monitoring unit 203 may transmit the latency data to the host 101 in an AER manner. For example, the latency monitoring unit 203 may transmit the latency data to the host 101 through the host I/F 201 or the sideband I/F 207.

In an embodiment, the latency monitoring unit 203 may differently set a criterion for dividing the time length of the latency into the plurality of time periods depending on the command type. Alternatively or additionally, the latency monitoring unit 203 may differently set the threshold value for the number of the latency occurrences of each of the time periods. In an embodiment, the latency monitoring unit 203 may differently set the range of each of the time periods.

The memory I/F 205 may provide an interface between the storage controller 200 and the NVM 300. For example, the storage controller 200 may receive data stored in the NVM 300 through the memory I/F 205, and may transmit data to be stored in the NVM 300.

The sideband I/F 207 may transmit and/or receive a packet to and/or from the host 101. The sideband I/F 207 may include an additionally provided interface in addition to the host I/F 201. For example, the sideband I/F 207 may communicate with the host 101 according to a protocol defined in a management component transport protocol (MCTP) specification and/or standard or a system management bus (SMBus) specification and/or standard. Alternatively or additionally, the host 101 may use various protocols such as, but not limited to, a universal asynchronous receiver and transmitter (UART) protocol, an inter-integrated circuit (I2C) protocol, a high-speed inter-chip (HSIC) protocol, a serial programming interface (SPI) protocol, or the like as a physical layer. However, the present disclosure is not limited thereto, and the sideband I/F 207 may adopt one or more of various sideband interface protocols to assist the host I/F 201.

The H core 209, the F core 211, and the N core 213 may control an overall operation of the storage device 103. In an embodiment, each of the H core 209, the F core 211, and the N core 213 may include an instruction tightly-coupled memory (ITCM) that may store an one or more instructions to be executed in each processing core (e.g., the H core 209, the F core 211, and the N core 213), and a data tightly-coupled memory (DTCM) that may store data used in each processing core (e.g., the H core 209, the F core 211, and the N core 213).

In an embodiment, the storage device 103 may logically include a plurality of layers. For example, the H core 209 may execute a host interface layer (HIL) that may be implemented as firmware. The HIL may communicate with the host 101 through host I/F 201. In an embodiment, the HIL may parse a command received from the host 101, and may provide a response to the command to the host 101.

As another example, the F core 211 may execute a flash translation layer (FTL) that may be implemented as firmware. The FTL may perform several functions such as, but not limited to, address mapping, wear-leveling, garbage collection, or the like. The address mapping function may refer to an operation of changing a logical address received from the host 101 to a physical address used to physically store data within the NVM 300. For example, the logical address may be the logical block address LBA used by the host 101. The wear-leveling function may refer to a technology that may reduce and/or prevent excessive deterioration of a particular block by allowing blocks in the nonvolatile memory NVM 300 to be uniformly used. For example, the wear-leveling function may balance erase counts of physical blocks. The garbage collection function may refer to a technology that may secure usable capacity in the NVM 300 by copying valid data of a block to a new block and erasing the existing block.

As another example, the N Core 213 may execute a flash interface layer (FIL) that may be implemented as firmware. The FIL may control a program operation, a read operation, an erase operation, or the like of the NVM 300 by converting a command from the host 101 to a command used in the NVM 300.

If various errors and/or problems occur in the storage device 103, the debug controller 215 may collect a state at a time point when the error and/or a failure occurs in the storage device 103 to generate dump data. The dump data may be and/or may include overall log data about an internal state of the storage device 103 at the time points when the errors and/or failures occurred. Alternatively or additionally, the dump data may include additional data related to additional time points that may occur immediately preceding and/or immediately following the time points when the errors and/or failures occurred. In an embodiment, the dump data may include at least one of an average erase count per block of the storage device 103, a data write count per block of the storage device 103, a number of defective blocks within the SSD, an error rate per block, a number of blocks in an error correction code (ECC) state, a device temperature, or the like.

In an embodiment, the debug controller 215 may transmit the dump data to the host 101 in response to a command received from the host 101. In such an embodiment, the debug controller 215 may transmit the dump data to the host 101 through the host I/F 201 and/or the sideband I/F 207. The host 101 may analyze a cause of an error occurring in the storage device 103, and may perform debugging for removing a defect.

The buffer memory 217 may store a command and/or data that may be executed and/or processed by the storage controller 200. For example, the buffer memory 217 may temporarily store data stored in and/or data to be stored in the NVM 300. Signals buffered in the buffer memory 217 may be transferred to the NVM 300 through the memory I/F 205 to be used in the NVM 300. For example, the data DATA buffered in the buffer memory 217 may be programmed in the NVM 300. In an embodiment, the buffer memory 217 may store the latency data and the latency table generated by the latency monitoring unit 203. In an embodiment, the buffer memory 217 may store the dump data generated by the debug controller 215.

The buffer memory 217 may be implemented as a volatile memory such as, but not limited to, a dynamic random access memory (DRAM), a static RAM (SRAM), or the like. However, the present disclosure is not limited thereto, and the buffer memory 217 may be implemented various other types of memory such as, but not limited to, MRAM, PRAM, ReRAM, flash memory, nano-floating gate memory (NFGM), polymer random access memory (PoRAM), FRAM, or the like.

FIG. 3 is a view showing the NVM, according to an embodiment.

Referring to FIG. 3, the memory device 300 may include a control logic 310, a memory cell array 320, a page buffer unit (or a page buffer portion) 350, a voltage generator 330, and a row decoder 340.

The control logic 310 may generally control various operations within the memory device 300. In an embodiment, the control logic 310 may output various control signals in response to the command CMD and/or the address ADDR from the memory I/F 205 of FIG. 2. For example, the control logic 310 may output a voltage control signal CTRL_vol, a row address X-ADDR, and a column address Y-ADDR.

The memory cell array 320 may be and/or may include a plurality of memory blocks (e.g., a first memory block BLK1, a second memory block BLK2, to a z-th memory block BLKz, hereinafter “BLK”), where z is a positive integer greater than two (2). Each of the plurality of memory blocks BLK may be and/or may include a plurality of memory cells. The memory cell array 320 may be connected to the page buffer unit 350 through bit lines BL, and may be connected to the row decoder 340 through word lines WL, string selection lines SSL, and ground selection lines GSL.

In an embodiment, the memory cell array 320 may be and/or may include a 3D memory cell array, and the 3D memory cell array may include a plurality of NAND strings. Each NAND string may include memory cells respectively connected to word lines vertically stacked above a substrate and/or on a substrate. Alternatively or additionally, the memory cell array 320 may be and/or may include a 2D memory cell array, and the 2D memory cell array may include a plurality of NAND strings disposed along row and/or column directions.

The page buffer unit 350 may include a plurality of page buffers (e.g., a first page buffer PB1, a second page buffer PB2, to an n-th page buffer PBn, hereinafter “PB”), where n is a positive integer greater than two (2). The plurality of page buffers PB may be respectively connected to the memory cells through the bit lines BL. The page buffer unit 350 may select at least one bit line from among the bit lines BL in response to the column address Y-ADDR. The page buffer unit 350 may operate as a write driver and/or a sense amplifier depending on an operating mode. For example, during a program operation, the page buffer unit 350 may apply a bit line voltage corresponding to data to be programmed to the selected bit line. As another example, during a read operation, the page buffer unit 350 may detect (or sense) data stored in the memory cell by detecting an electric current and/or a voltage of the selected bit line.

The voltage generator 330 may generate various types of voltages for performing the program, read, and/or erase operations based on the voltage control signal CTRL_vol. For example, the voltage generator 330 may generate a program voltage, a read voltage, a program verification voltage, an erase voltage, or the like as a word line voltage VWL.

The row decoder 340 may select one of the word lines WL in response to the row address X-ADDR, and/or may select one of the string selection lines SSL. For example, during a program operation, the row decoder 340 may apply the program voltage and the program verification voltage to the selected word line. As another example, during a read operation, the row decoder 340 may apply the read voltage to the selected word line.

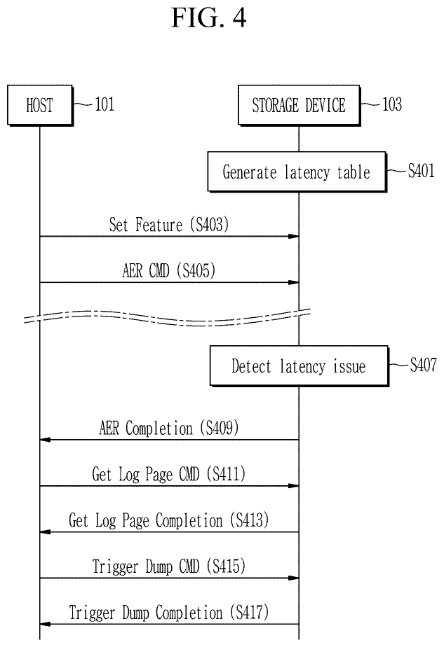

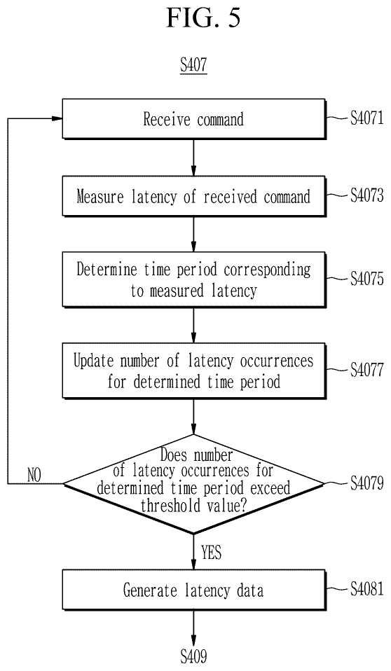

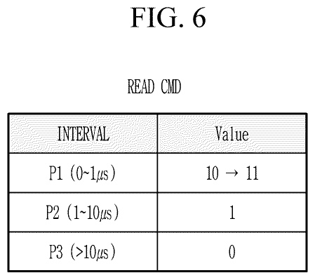

FIG. 4 is a flowchart showing an operating method of the storage system, according to an embodiment. FIG. 5 is a flowchart showing an operation of detecting the latency issue of FIG. 4, according to an embodiment. FIG. 6 is a view showing the latency table, according to an embodiment.

The storage device 103 may generate the latency table (operation S401).

Referring to FIG. 6 together, the storage device 103 may generate the latency table using a bucket. For example, the latency table shown in FIG. 6 may correspond to a read command (READ CMD). In an embodiment, the storage device 103 may divide a time period of the latency into the plurality of time periods (e.g., a first time period P1, a second time period P2, and a third time period P3) based on a predetermined condition. For example, as shown in FIG. 6, the first time period P1 may be between about zero (0) microseconds (μs) and about one (1) μs (e.g., 0≤P1<1), the second time period P2 may be between one (1) μs and about ten (10) μs (e.g., 1≤P2<10), and the third time period P3 may be greater than about ten (10) μs (e.g., P3≥10). In such an example, the storage device 103 may set the threshold value of the first time period P1 to ten (10), may set the threshold value of the second time period P2 to five (5), and may set the threshold value of the third time period P3 to one (1). That is, the storage device 103 may determine that a latency issue is detected if the number of latency occurrences detected in the first time period P1 exceeds ten (10), or the number of latency occurrences detected in the second time period P2 exceeds five (5), or the number of latency occurrences detected in the third time period P3 exceeds one (1). However, the present disclosure is not limited in this regard, and the thresholds of the first to third time periods P1 to P3 may be set to different values.

The host 101 may transmit a set features command (or a set feature command) to the storage device 103 (operation S403).

The set features command may include information on an operating condition of the storage device 103 determined by the host 101.

The host 101 may transmit an AER command to the storage device 103 (operation S405).

In an embodiment, the host 101 may transmit the AER command requesting latency information to the storage device 103. The AER command may be and/or may include a command for receiving the AER. In an embodiment, the host 101 may issue a predetermined number of AER commands. Thereafter, the host 101 may perform another operation in a state where a response to the AER command is received.

The storage device 103 may detect the latency issue (operation S407). The operation S407 of detecting the latency issue is further described with reference to FIGS. 5 and 6.

Referring to FIG. 5, the storage device 103 may receive the command (operation S4071).

For example, the storage device 103 may receive, from the host 101, at least one of a read command, a program command, a data set management command, or the like.

The storage device 103 may measure the latency of the received command (operation S4073).

For example, the storage device 103 may receive the read command. The storage device 103 may measure, as the latency, the time from a time point when the storage device 103 receives the read command to a time point when the storage device 103 transmits data corresponding to the read command to the host 101. For example, for ease of description, it may be assumed that the measured latency is about 0.5 μs. However, the present disclosure is not limited in this regard.

The storage device 103 may determine the time period corresponding to the measured latency (operation S4075).

In an embodiment, the storage device 103 may determine the latency table corresponding to a type of the received command within the latency table generated in operation S401. The storage device 103 may determine the time period in which the measured latency of the command is included in the latency table.

For example, referring to FIG. 6, if the measured latency is 0.5 μs, the storage device 103 may determine that the latency corresponds to the first time period P1.

The storage device 103 may update the number of latency occurrences of the determined time period (e.g., the first time period P1) (operation S4077).

In an embodiment, the storage device 103 may increase a count value of the number of the latency occurrences of the determined time period (e.g., the first time period P1) by one (1).

For example, a number of latency occurrences included in the first time period P1 (e.g., latencies between about zero (0) μs and about one (1) μs) may be ten (10), as shown in the latency table of FIG. 6, prior to the update operation (operation S4077). In such an example, the storage device 103 may update the number of the latency occurrences from ten (10) to eleven (11), as further shown in the latency table of FIG. 6.

The storage device 103 may determine whether the number of the latency occurrences of the determined time period exceeds the threshold value (operation S4079).

In an embodiment, the threshold value may be a predetermined value within the storage device 103. The threshold value may be different for each of the plurality of time periods. However, the present disclosure is not limited thereto, and the threshold value may be a predetermined value based on the set features command received from the host 101.

The storage device 103 may determine whether the number of the latency occurrences of the time period exceeds the threshold value of the time period in the updated latency table.

If the number of the latency occurrences of the determined time period does not exceed the threshold value (NO in operation S4079), the storage device 103 may return to the operation S4071.

Alternatively, if the number of the latency occurrences for the determined time period exceeds the threshold value (YES in operation S4079), the storage device 103 may generate the latency data (operation S4081).

In an embodiment, the storage device 103 may determine that the latency issue is detected. For example, the threshold value for the first time period P1 may be eleven (11), and as such, the storage device 103 may determine that the number of the latency occurrences for the first time period P1 (e.g., eleven (11)) exceeds the threshold value (e.g., eleven (11)). Accordingly, the storage device 103 may determine that the latency issue occurs, and may generate the latency data. That is, the storage device 103 may generate the latency data including at least one of a latency time (e.g., 0.5 μs), a time point when the request signal REQ causing the latency is received, the type of the received command (e.g., the read command), or the like.

In an embodiment, the storage device 103 may initialize the number of the latency occurrences for the time period within the latency table. For example, the storage device 103 may reset the number of the latency occurrences of the first time period P1 to zero (0).

Subsequently, the storage device 103 may proceed to perform operation S409 of the operation method depicted in FIG. 4.

Referring back to FIG. 4, if the latency issue is detected, the storage device 103 may transmit an AER completion signal to the host 101 (operation S409). For example, the storage device 103 may generate a signal corresponding to the AER command received in the operation S405. In an embodiment, because the storage device 103 may acquire the latency data by performing the latency issue detection operation in the operation S407, the storage device 103 may determine that a device request received from the host 101 is completed. Accordingly, the storage device 103 may generate the AER completion signal indicating that the command corresponding to the received device request is completed. The storage device 103 may transmit the generated AER completion signal to the host 101.

The host 101 may transmit a get log page command (e.g., a Get log page CMD) to the storage device 103 (operation S411). The host 101 may transmit the get log page command requesting the latency data to the storage device 103 in response to receiving the AER completion signal from the storage device 103.

The storage device 103 may transmit a get log page completion signal to the host 101 (operation S413). The storage device 103 may transmit the get log page completion signal including log data for the storage device 103 to the host 101 in response to the get log page command received from the host 101. In an embodiment, the get log page completion signal may include log data about the latency of the storage device 103.

The host 101 may analyze the latency of the storage device 103 based on the received get log page completion signal. In an embodiment, the host 101 may adjust, based on the analysis, a transmission timing of commands scheduled to be transmitted to the storage device 103.

In an embodiment, the host 101 may transmit a trigger dump command (e.g., Trigger Dump CMD) to the storage device 103 (operation S415). If the host 101 receives the get log page completion signal from the storage device 103, the host 101 may transmit the trigger dump command requesting the dump data from the storage device 103 to the storage device 103.

The storage device 103 may transmit a trigger dump completion signal to the host 101 (operation S417). For example, the storage device 103 may transmit the trigger dump completion signal to the host 101 in response to the trigger dump command received from the host 101. The trigger dump completion signal may include the dump data for the storage device 103. The dump data may include overall log data about an internal state of the storage device 103.

Based on the received dump data, the host 101 may analyze an error occurring in the storage device 103, and may analyze the internal state of the storage device 103. For example, analysis of the internal state of the storage device 103 may include, but not be limited to, analysis of whether performance of the storage device 103 is degraded, analysis of whether a performance requirement set by a user is met, analysis of whether performance meets an environment in which the host 101 is located, or the like.

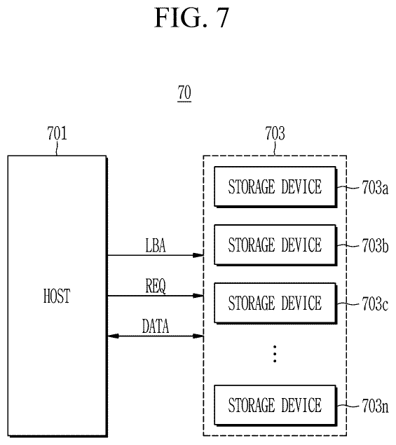

FIG. 7 is a view showing a storage system, according to an embodiment.

The storage system 70 may include a host 701 and a plurality of storage devices 703 (e.g., a first storage device 703a, a second storage device 703b, a third storage device 703c, to an n-th storage device 703n, hereinafter “703”, where n is a positive integer greater than two (2)).

The host 701 may control an overall operation of the storage system 70. For example, the host 701 may provide a request signal REQ and a logical block address LBA to the plurality of storage devices 703. For example, the request signal REQ may be and/or may include a command for storing data DATA in at least one storage device of the plurality of storage devices 703 and/or a command for reading data DATA stored in at least one storage device of the plurality of storage devices 703. In an embodiment, the request signal REQ may be and/or may include a command for obtaining information on a state of at least one storage device of the plurality of storage devices 703.

The plurality of storage devices 703 may be accessed by the host 701. In an embodiment, the plurality of storage devices 703 may store the data DATA and/or may process the data DATA in response to the request signal REQ from the host 701.

Each storage device of the plurality of storage devices 703 may include and/or may be similar in many respects to the storage device 103 described above with reference to FIGS. 1 to 6, and may include additional features not mentioned above. Consequently, repeated descriptions of the plurality of storage devices 703 described above with reference to FIGS. 1 to 6 may be omitted for the sake of brevity.

In an embodiment, the first storage device 703a may have a high priority and the second storage device 703b may have a low priority. However, the present disclosure is not limited in this regard. For example, in an embodiment, the first storage device 703a may have the low priority and the second storage device 703b may have the high priority. Alternatively or additionally, the first and second storage devices 703a and 703b may a same priority and the third storage device 703c may have a different priority from the first and second storage devices 703a and 703b.

In an embodiment, the host 701 may preset whether an operation for detecting a latency issue for each storage device of the plurality of storage devices 703 is performed according to a priority of each storage device of the plurality of storage devices 703. The priority of the plurality of storage devices 703 may be set in advance, for example. However, the present disclosure is not limited in this regard. For example, in an embodiment, the priority the plurality of storage devices 703 may be set based on an operating condition received from the host 701.

For example, the host 701 may set the first storage device 703a not to perform the operation for detecting the latency issue, and may set the second storage device 703b to perform the operation for detecting the latency issue. In an embodiment, the host 701 may perform a polling operation for checking an internal state of the first storage device 703a at regular (e.g., periodic) periods on the first storage device 703a. However, the present disclosure is not limited in this regard, and the host 701 may perform the polling operation in a semi-persistent and/or aperiodic (e.g., based on triggering) manner.

In an embodiment, the host 701 may differently set operating conditions for the plurality of storage devices 703 according to the priority of each of the plurality of storage devices 703. For example, the number of time periods of a latency table for the first storage device 703a with the high priority may be greater than the number of time periods of a latency table for the second storage device 703b with the low priority. Similarly, a range of the time period of the first storage device 703a may be larger than a range of the time period of the second storage device 703b. As another example, a threshold value of the number of latency occurrences for each of a plurality of time periods of the first storage device 703a may be less than a threshold value of the number of latency occurrences for each of the plurality of time periods of the second storage device 703b. However, the present disclosure is not limited thereto, and the host 701 may differently set conditions of latency issue detection operations for the plurality of storage devices 703 based on the priorities of the plurality of storage devices 703.

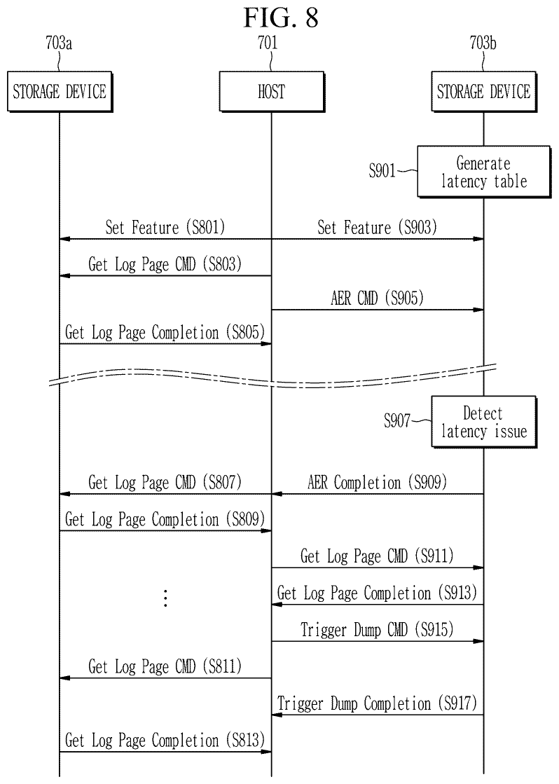

FIG. 8 is a view showing an operating method of the storage system according to FIG. 7, according to an embodiment.

The host 701 may transmit a set features command to the first storage device 703a (operation S801).

The host 701 may transmit a get log page command (e.g., Get log page CMD) to the first storage device 703a (operation S803).

The first storage device 703a may transmit a get log page completion signal to the host 701 (operation S805).

The plurality of storage devices 703 may transmit the get log page completion signal including log data for the plurality of storage devices 703 to the host 701 in response to the get log page command received from the host 701. For example, the get log page completion signal may include log data about the latency of the plurality of storage devices 703.

In an embodiment, the host 701 may transmit the get log page command to the first storage device 703a every predetermined period. For example, the host 701 may transmit the get log page command to the first storage device 703a (operation S807). The first storage device 703a may transmit the get log page completion signal to the host 701 (operation S809). After a predetermined time, the host 701 may transmit the get log page command to the first storage device 703a (operation S811). The first storage device 703a may transmit the get log page completion signal to the host 701 (operation S813).

While the host 701 may perform the polling operation on the first storage device 703a to detect the internal state (e.g., the latency) of the first storage device 703a, the second storage device 703b may independently perform the latency issue detection operation. For example, at a substantially similar time and/or the same time that the host 701 performs the polling operation on the first storage device 703a, the second storage device 703b may independently perform the latency issue detection operation.

Continuing to refer to FIG. 8, the second storage device 703b may generate the latency table (operation S901).

The host 701 may transmit a set features command to the second storage device 703b (operation S903).

The host 701 may transmit an AER command to the second storage device 703b (operation S905).

The second storage device 703b may detect the latency issue (operation S907). Operation S907 may include and/or may be similar in many respects to operation S407 described with reference to FIGS. 4 and 5, and may include additional features not mentioned above. Consequently, repeated descriptions of the operation S907 described above with reference to FIGS. 4 and 5 may be omitted for the sake of brevity.

If the latency issue is detected, the second storage device 703b may transmit an AER completion signal to the host 701 (operation S909).

The host 701 may transmit a get log page command (Get log page CMD) to the second storage device 703b (operation S911).

The second storage device 703b may transmit a get log page completion signal to the host 701 (operation S913).

In an embodiment, the host 701 may transmit a trigger dump command (e.g., Trigger Dump CMD) to the second storage device 703b (operation S915).

The second storage device 703b may transmit a trigger dump completion signal to the host 701 (operation S917).

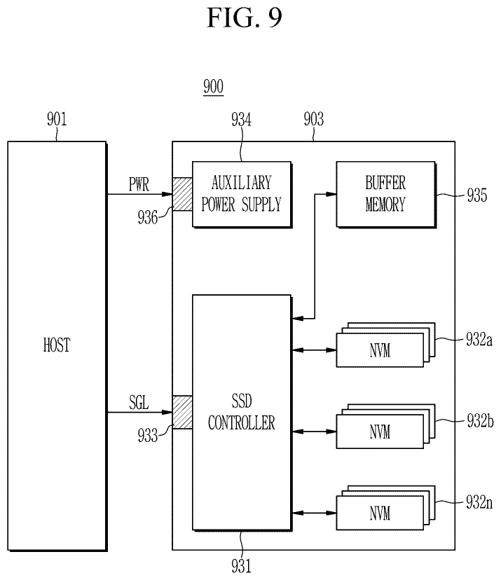

FIG. 9 is a block diagram showing an SSD system, according to an embodiment.

Referring to FIG. 9, the SSD system 900 may include a host 901 and an SSD 903. The SSD 903 may exchange signals SGL with the host 901 through a signal connector 933, and/or may receive an electric power PWR through a power connector 936. The SSD 903 may include an SSD controller 931, an auxiliary power supply 934, a buffer memory 935, and a plurality of memory devices (e.g., a first memory device 932a, a second memory device 932b, to an n-th memory device 932n, hereinafter “932”, where n is a positive integer greater than two (2)). The plurality of memory devices 932 may be and/or may include a plurality of NAND flash memory devices. In an embodiment, the SSD controller 931 may include and/or may be similar in many respects to the storage controller 200 described with reference to FIGS. 1 to 8, and may include additional features not mentioned above. Consequently, repeated descriptions of the SSD controller 931 described above with reference to FIGS. 1 to 8 may be omitted for the sake of brevity.

In an embodiment, the SSD controller 931 may transmit an entire state read command to the plurality of memory devices 932 in order to detect a state of each of the plurality of memory devices 932. Each memory device of the plurality of memory devices 932 may output state data in response to the entire state read command. The SSD controller 931 may receive the state data from the plurality of memory devices 932. The SSD controller 931 may output the state data of each of the plurality of memory devices 932 as one entire state data to the host 901 through a plurality of data pins (e.g., signal connector 933).

In an embodiment, the SSD controller 931 may generate a latency table according to a type of a command for the plurality of memory devices 932 based on an operating condition received from the host 901. The latency table may include a plurality of time periods for dividing a time length of the latency and the number of latency occurrences for each of the plurality of time periods. The SSD controller 931 may divide the time length of the latency into the plurality of time periods, and may count the number of the latency occurrences of each of the plurality of time periods. The SSD controller 931 may determine whether a time period is included in the time period among the plurality of time periods depending on the time length of the latency. Alternatively or additionally, if the number of the latency occurrences of the time period exceeds a threshold value of the time period, the SSD controller 931 may transmit latency data to the host 901. For example, the latency data may include the time length of the latency, a time point when the command causing the latency is received, information on the command causing the latency, or the like.

The SSD controller 931 may transmit the latency data to the host 901 only when the number of the latency occurrences exceeds a predetermined threshold value of the number of latency occurrences within the latency table. Accordingly, the host 901 may not perform a polling operation to check a state of the storage device at regular periods. As such, a processing and/or performance burden on the host 901 may be reduced, when compared to related storage devices. Alternatively or additionally, because log data including information on the latency issue may be generated only when the number of the latency occurrences exceeds the threshold value, the processing and/or performance burden on the SSD 903 may be further reduced, when compared to the related storage devices.

As described above, the embodiments have been disclosed in the drawings and the specification. Although specific terms have been used herein, the terms are used only for the purpose of describing the present disclosure and are not used to limit the scope of the present disclosure as defined in the meaning or claims. Therefore, those skilled in the art may understand that various modifications and other equivalent embodiments of the present disclosure are possible. Therefore, the true technical protective scope of the present disclosure must be determined based on the technical spirit of the appended claims.

What is claimed is:

1. A storage system, comprising:
a host; and
a storage device configured to:
receive, from the host, a plurality of first type commands;
measure a plurality of latencies of the plurality of first type commands;
count a number of occurrences of the plurality of latencies within a first time period, the first time period being a time length among the plurality of latencies;
generate latency data comprising time points when each of the plurality of first type commands are received, based on the number of occurrences exceeding a predetermined threshold value; and
output, to the host, the latency data based on an asynchronous event request (AER) command being received from the host.

2. The storage system of claim 1, wherein the storage device is further configured to:
receive, from the host, an operating condition comprising at least one of a number of a plurality of time periods dividing time lengths of the plurality of latencies, a range of each of the plurality of time periods, or the predetermined threshold value of the number of occurrences of each of the plurality of time periods, the plurality of time periods comprising the first time period; and
generate a latency table for the plurality of first type commands based on the operating condition.

3. The storage system of claim 2, wherein a first predetermined threshold value of the first time period is different from a second predetermined threshold value of a second time period from among the plurality of time periods.

4. The storage system of claim 2, wherein a first range of the first time period is different from a second range of a second time period from among the plurality of time periods.

5. The storage system of claim 1, wherein the latency data comprises at least one time length of the plurality of latencies, based on the number of occurrences of the plurality of latencies exceeding the predetermined threshold value, or information on the plurality of first type commands.

6. The storage system of claim 1, wherein the storage device is further configured to:
receive, from the host, the AER command through a host interface; and
output, to the host, the latency data through the host interface.

7. The storage system of claim 1, wherein the storage device is further configured to:
receive, from the host, the AER command through a sideband interface; and
output, to the host, the latency data through the sideband interface.

8. The storage system of claim 1, wherein the storage device is further configured to:
collect a state at a time point when an error occurs in the storage device to generate dump data regarding an internal state of the storage device; and
output, to the host, the dump data based on a trigger dump command from the host.

9. An operating method of a storage system, the operating method comprising:
receiving an operating condition of a latency issue detection operation;
generating a latency table based on the operating condition;
receiving an asynchronous event request (AER) command;
receiving a plurality of first type commands;
measuring a plurality of latencies of the plurality of first type commands;
counting a number of occurrences of the plurality of latencies within a first time period, the first time period being a time length among the plurality of latencies;
detecting a latency issue based on the number of occurrences exceeding a predetermined threshold value; and
transmitting latency data comprising time points when each of the plurality of first type commands are received, based on the AER command.

10. The operating method of claim 9, wherein the operating condition comprises at least one of a number of a plurality of time periods dividing time lengths of the plurality of latencies, a range of each of the plurality of time periods, or the predetermined threshold value of the number of occurrences of each of the plurality of time periods, and
wherein the plurality of time periods comprises the first time period.

11. The operating method of claim 10, wherein the detecting of the latency issue comprises:
determining time periods from among the plurality of time periods corresponding to the plurality of latencies; and
updating the number of occurrences of the determined time periods.

12. The operating method of claim 10, wherein a first predetermined threshold value of the first time period is different from a second predetermined threshold value of a second time period from among the plurality of time periods.

13. The operating method of claim 10, wherein a first range of the first time period is different from a second range of a second time period from among the plurality of time periods.

14. The operating method of claim 9, wherein the generating of the latency table comprises:
generating a plurality of latency tables respectively corresponding to a plurality of command types.

15. The operating method of claim 9, further comprising:
receiving a trigger dump command;
generating dump data regarding an internal state of a storage device by collecting a state of the storage device at a time point when an error occurs in the storage device; and
transmitting the dump data based on the trigger dump command.

16. A storage device, comprising:
a host interface configured to receive a plurality of first type commands;
a memory storing instructions and one or more processors communicatively coupled to the host interface and to the memory, wherein the one or more processors are configured to execute the instructions to:
measure a plurality of latencies of the plurality of first type commands;
count a number of occurrences of the plurality of latencies within a first time period, the first time period being a time length among the plurality of latencies;
generate latency data comprising time points when each of the plurality of first type commands are received, based on the number of occurrences exceeding a predetermined threshold value; and
output, through the host interface, the latency data based on an asynchronous event request (AER) command.

17. The storage device of claim 16, wherein the one or more processors are further configured to execute further instructions to:
receive an operating condition comprising at least one of a number of a plurality of time periods dividing time lengths of the plurality of latencies, a range of each of the plurality of time periods, or the predetermined threshold value of the number of occurrences of each of the plurality of time periods; and
generate a latency table for each of the plurality of first type commands, based on the operating condition.

18. The storage device of claim 17, further comprising:
a buffer memory configured to store the latency data and the latency table.

19. The storage device of claim 16, further comprising:
a sideband interface configured to receive the AER command,
wherein the one or more processors are further configured to execute further instructions to output the latency data through the sideband interface.

20. The storage device of claim 16, further comprising:
a debug controller configured to:
collect a state at a time point when an error occurs in the storage device;
generate dump data regarding an internal state of the storage device; and
output the dump data based on a trigger dump command.
